(19) United States
(12) Patent Application Publication
(10) Pub. No.: US 2013/0020315 A1
(43) Pub. Date: Jan. 24, 2013

(54) HIGH FREQUENCY COOKING DEVICE

(71) Applicants: Norikimi Tatsumu, Osaka-Shi (JP); Kenichi Aoyama, Osaka-Shi (JP)

(72) Inventors: Norikimi Tatsumu, Osaka-Shi (JP); Kenichi Aoyama, Osaka-Shi (JP)

(73) Assignee: SHARP KABUSHIKI KAISHA, Osaka-shi, Osaka (JP)

(21) Appl. No.: 13/637,941

(22) PCT Filed: Mar. 31, 2011
(86) PCT No.: PCT/JP2011/058280

§ 371 Date: Sep. 27, 2012

(30) Foreign Application Priority Data
Apr. 1, 2010 (JP) 2010-085406

(51) Int. Cl. H05B 6/80

(52) U.S. Cl. 219/725

(57) ABSTRACT

Supplied in a heating chamber (20) of the disclosed high frequency cooking device (1) are high frequency waves generated by oscillation of a high frequency wave generating device (21). On the bottom wall of the heating chamber (20), a roller stay (31) is mounted with and rotates a turn table (30). Between the bottom surface of the turn table (30) and the bottom wall of the heating chamber (20), a tilt limiting member is positioned which prevents the turn table (30) from being tilted to or beyond a prescribed angle. The tilt limiting member comprises a protrusion (50) formed on the bottom wall of the heating chamber (20), a protrusion (51) formed on the bottom surface of the turn table (30), and a linking stay (52) linking an arm (31b) of the roller stay (31).

### TECHNICAL FIELD

The present invention relates to a high frequency cooking device.

### BACKGROUND ART

A high frequency cooking device, which vibrates molecules of food by means of high frequency wave (microwave) to heat the food from inside, is generally called a “microwave oven”, and is a familiar commodity of households.

Some high frequency cooking devices have a turntable on which a food is placed. The turntable should rotate stably keeping a predetermined position. Proposals have been made to date to meet such a requirement. An example of the proposal is shown in patent document 1.

In a high frequency cooking device described in patent document 1, a displacement detection means for detecting vertical displacement of the turntable during rotation thereof is disposed under an undersurface of an outer circumferential portion of the turntable. Even if the turntable only slightly fluctuates in rotation, the displacement detection means quickly detects the fluctuation, accordingly, a user can figure out that the position of a food placed is deviated from a center of the turntable.

There are various methods for supporting the turntable, one of which is employment of a roller stay. A roller stay is a device including a plurality of arms disposed radially, each of the arms is equipped with a roller at a tip end thereof. The roller stay is placed on a bottom wall of a heating chamber, and the turntable is placed on the roller stay. When the roller stay rotates, the turntable also rotates. An example of such structure is shown in patent document 2.

### CITATION LIST

### Patent Literature

PLT1: JP-A-2001-90957

PLT 1: JP-A-1994-241876

### SUMMARY OF INVENTION

### Technical Problem

As in the case of high frequency cooking device described in patent document 2, if a turntable is supported by a roller stay, the support becomes stable, and it becomes possible to place a fairly heavy food on the turntable. However, rollers of the roller stay do not support the outermost circumferential portion of the turntable but typically support a portion nearer to a center of rotation. Because of this, if force is exerted on a portion of the turntable that extends beyond a circumference of the roller stay, the turntable could be tilted significantly to come off the roller stay.

The present invention has been made in light of the above problem, and it is an object of the present invention to provide a high frequency cooking device with a turntable supported by a roller stay, characterized in that if force is exerted on a rim of the turntable, the turntable does not tilt to such an extent that the turntable comes off the roller stay.

### Solution to Problem

According to a preferred embodiment of the present invention, the high frequency cooking device includes: a heating chamber that heat a food; a roller stay that is disposed on a bottom wall of the heating chamber and rotates with a turntable placed thereon; and a tilt limiting member that is disposed between an undersurface of the turntable and the bottom wall of the heating chamber; wherein the tilt limiting member prevents the turntable from being tilted over a predetermined angle.

According to a preferred embodiment, in the high frequency cooking device having the above structure, on the bottom wall of the heating chamber, a protrusion is formed at a position between a front side opening of the heating chamber and the roller stay, and the protrusion defines the tilt limiting member.

According to a preferred embodiment, in the high frequency cooking device having the above structure, on the undersurface of the turntable, a protrusion is formed along an arc larger than the roller stay in diameter, and the protrusion defines the tilt limiting member.

According to a preferred embodiment, in the high frequency cooking device having the above structure, the roller stay includes a plurality of arms, each of the arms is equipped with a roller at a tip end thereof, and the neighboring arms are connected by a linking stay, and the linking stay defines the tilt limiting member.

### Advantageous Effects of Invention

According to the present invention, the tilt limiting member is disposed between the undersurface of the turntable and the bottom wall of the heating chamber, accordingly, even if force is exerted on a portion of the turntable that extends beyond a circumference of the roller stay, the turntable does not tilt to such an extent that the turntable comes off the roller stay. Because of this, the turntable rotates stably keeping a predetermined position.

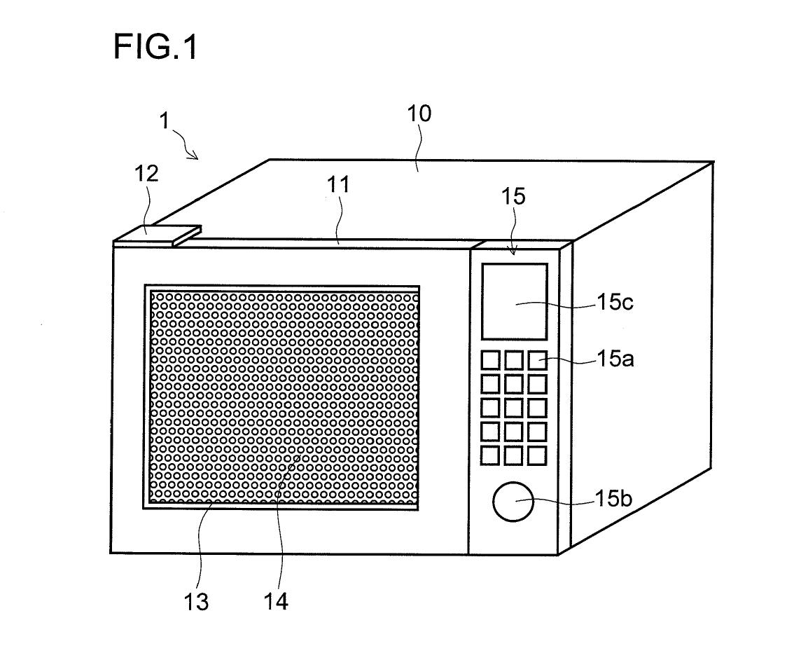

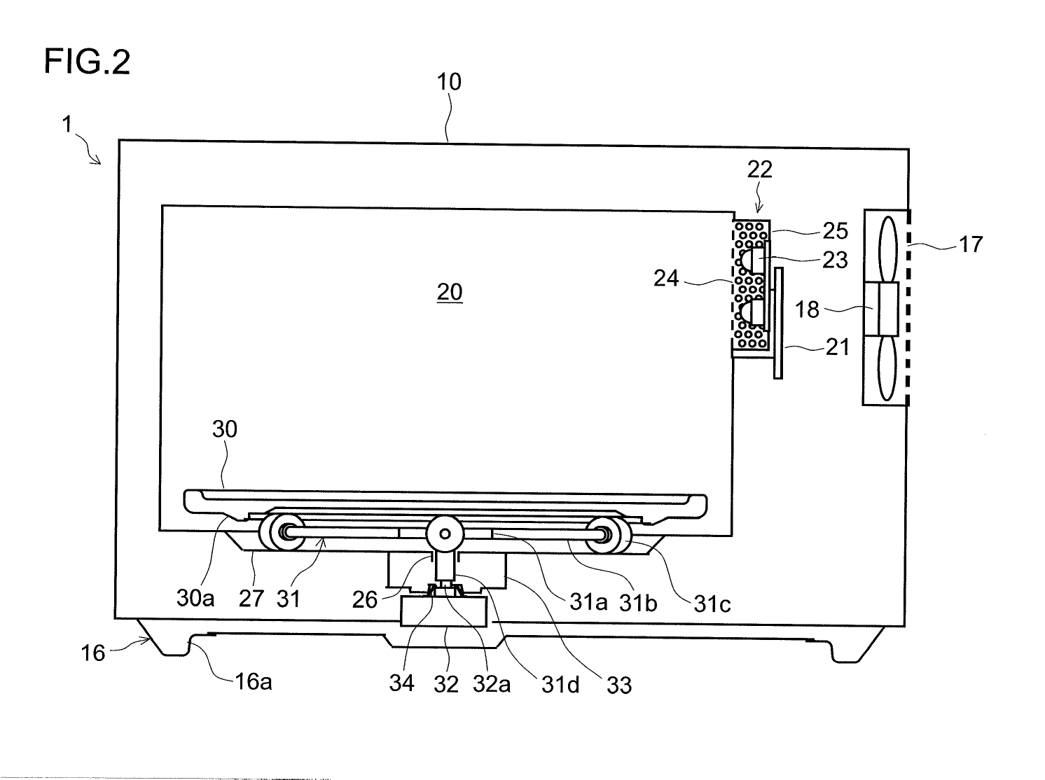

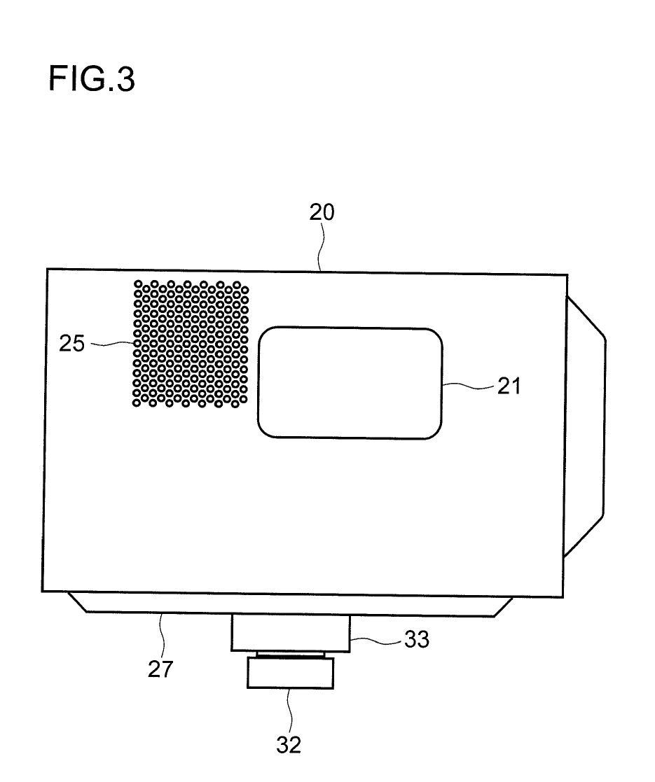

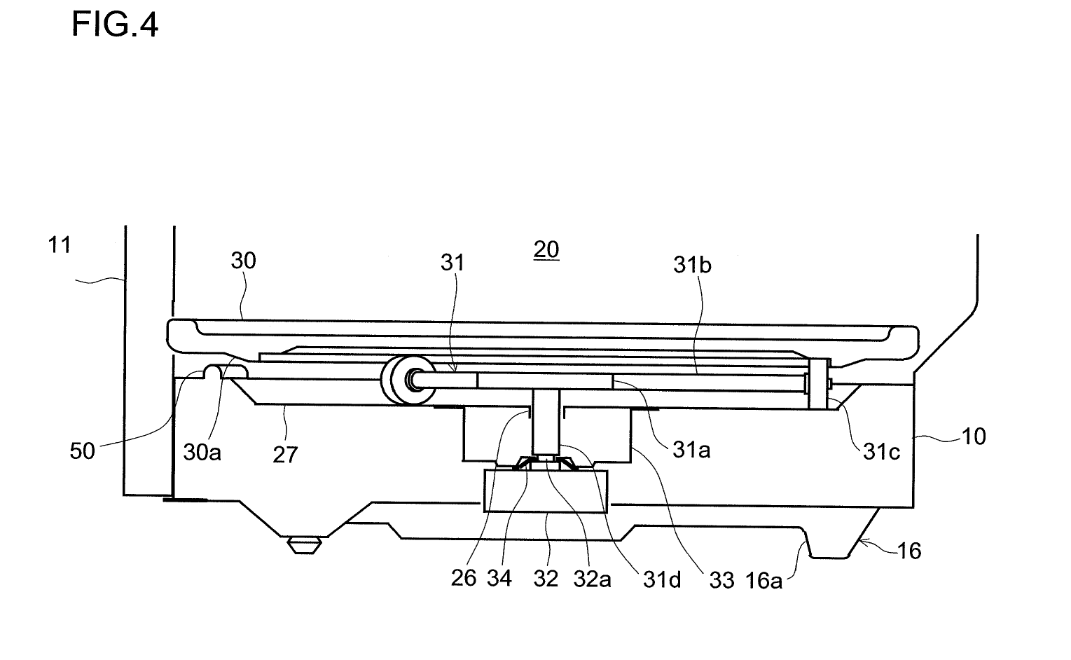

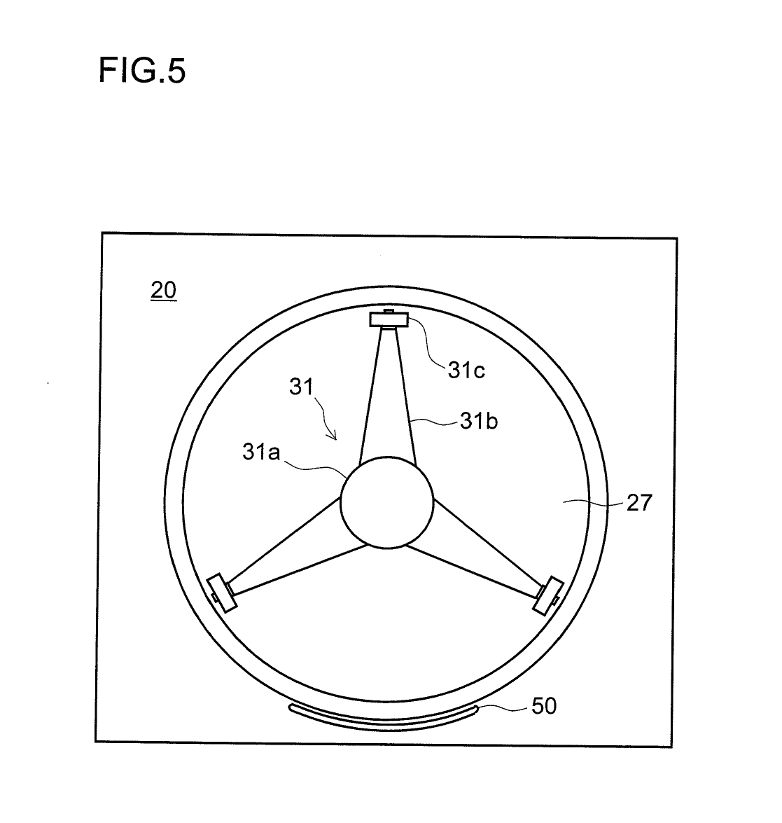

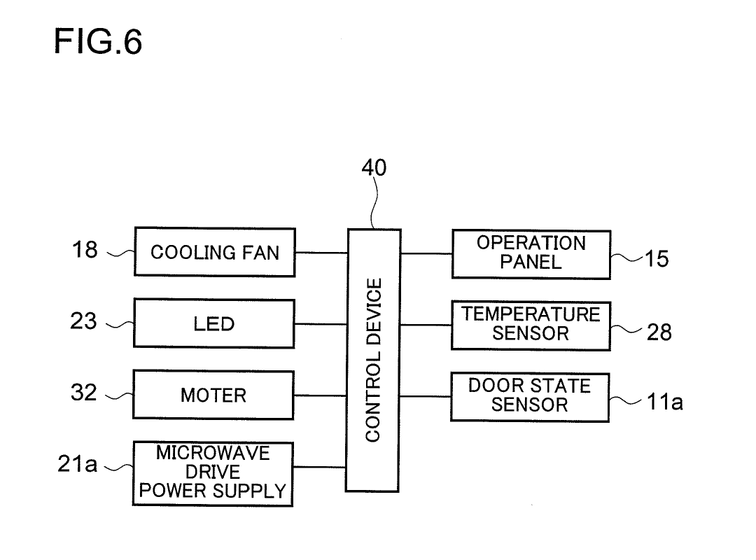

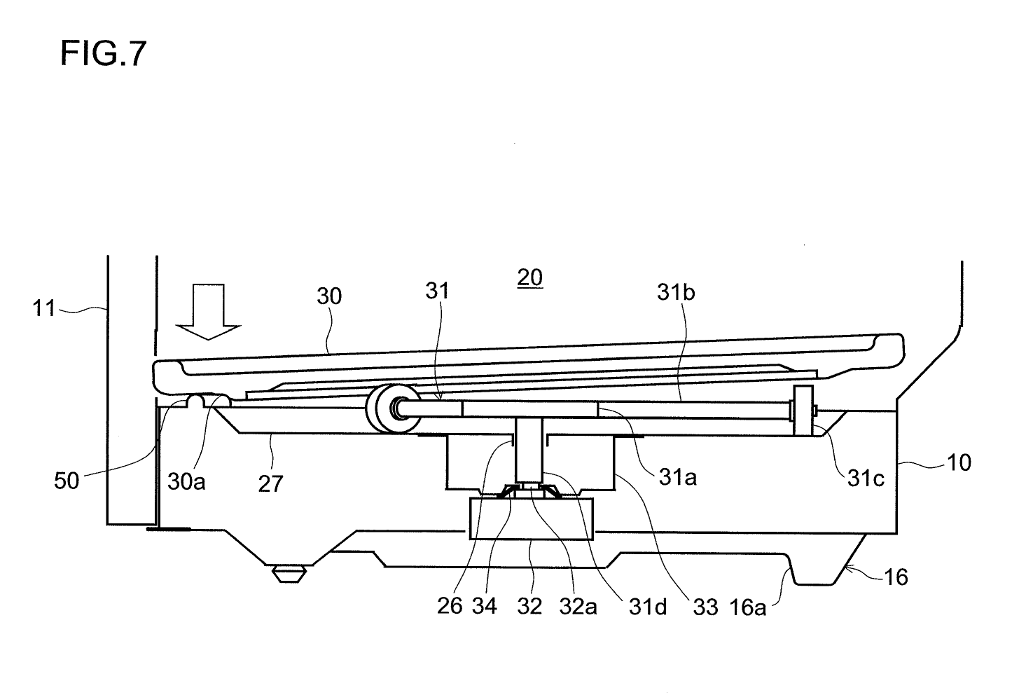

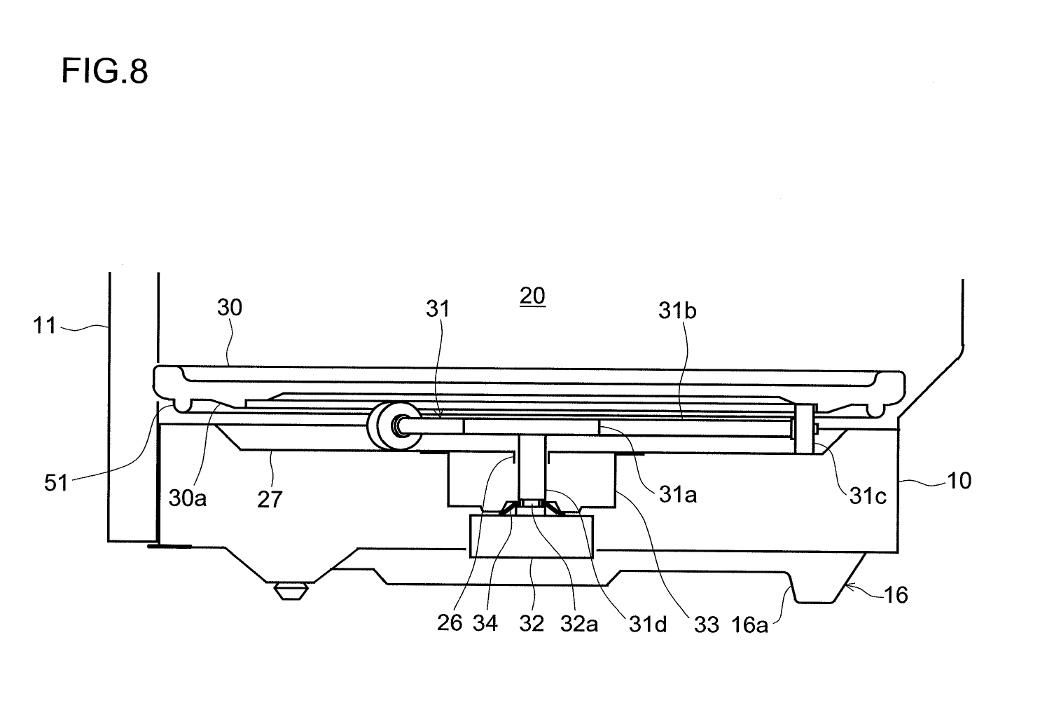

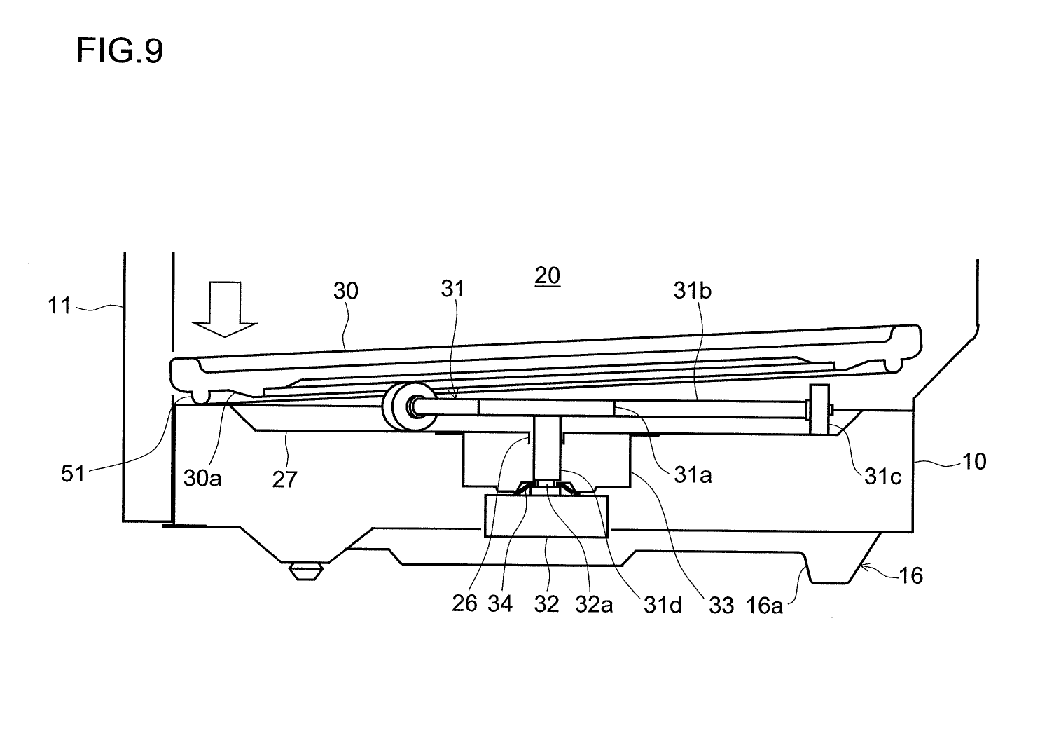

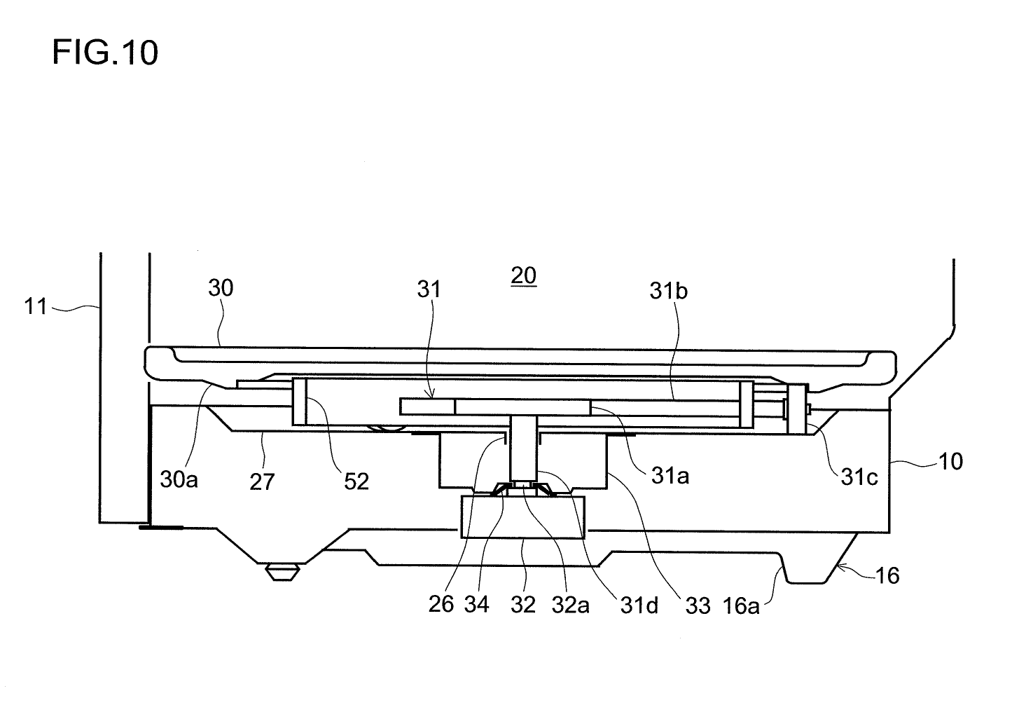

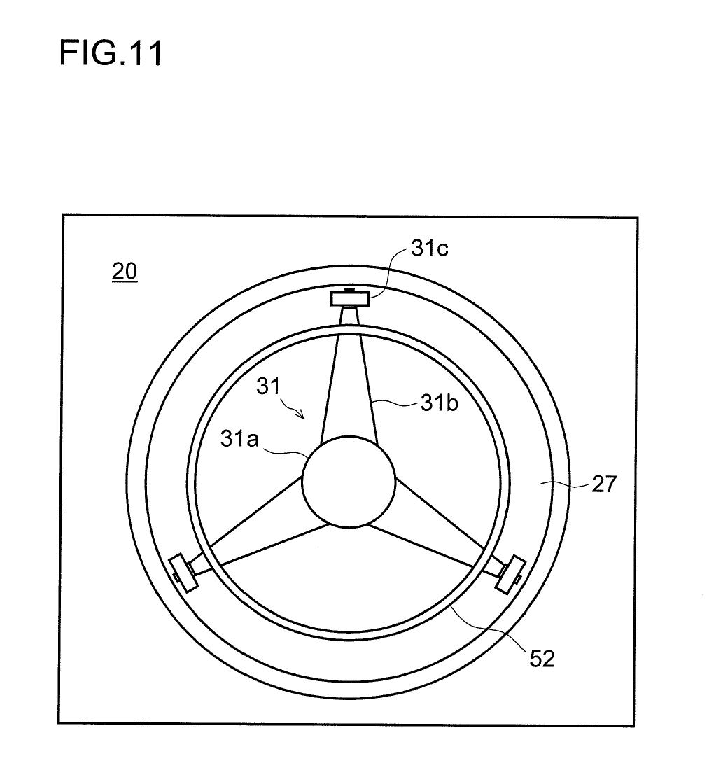

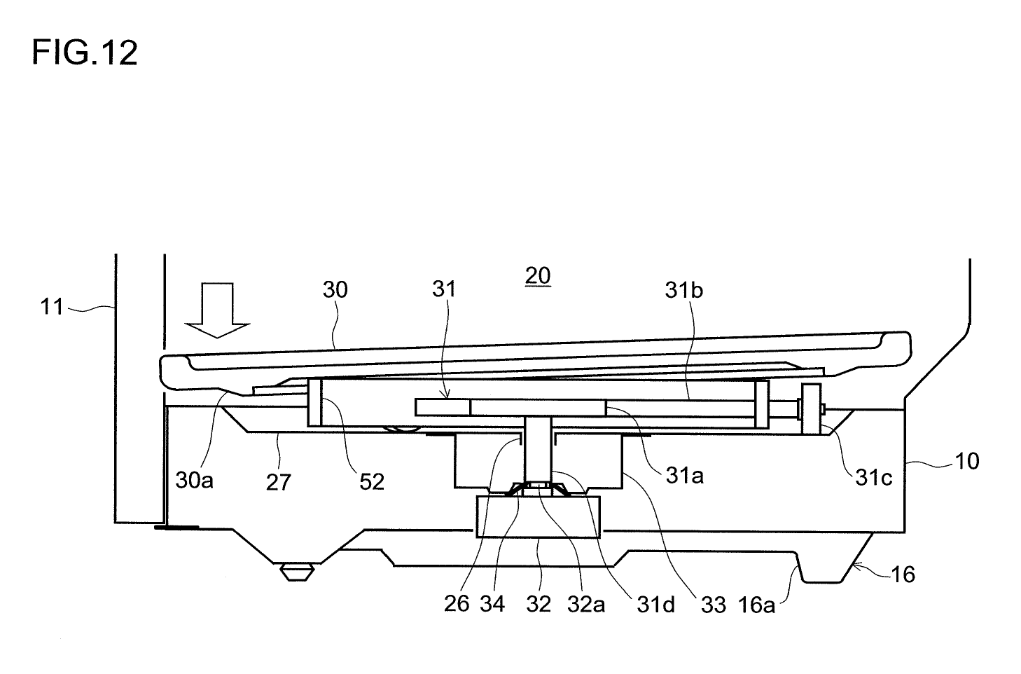

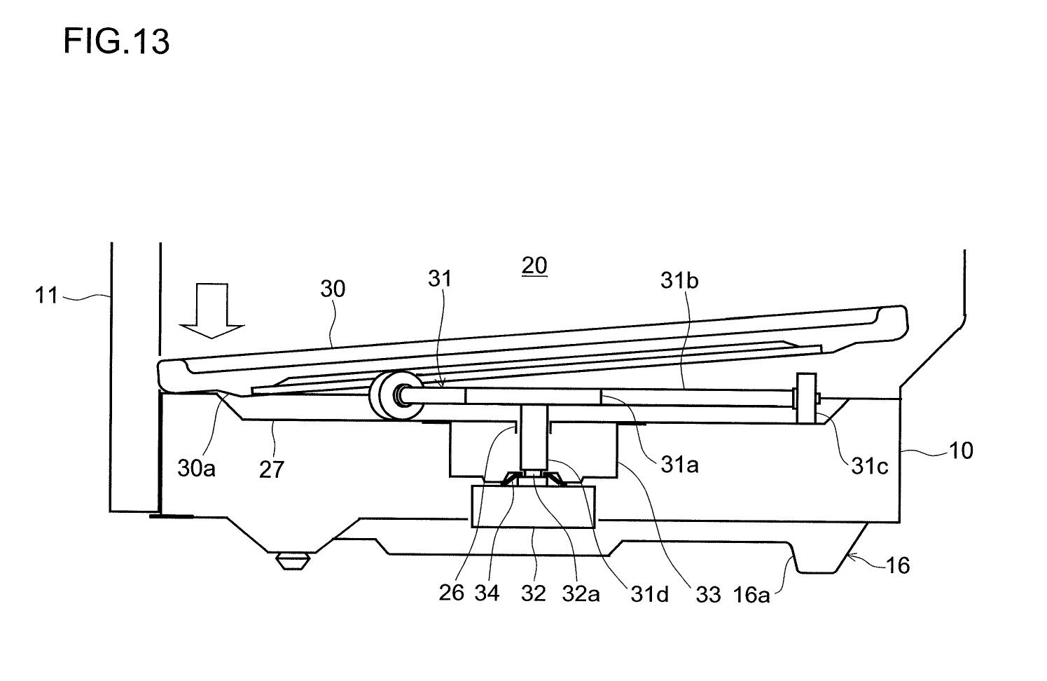

### BRIEF DESCRIPTION OF DRAWINGS

[FIG. 1] is a perspective view of a high frequency cooking device according to a first embodiment of the present invention.

[FIG. 2] is a schematic vertical sectional view showing innards of a high frequency cooking device.

[FIG. 3] is a side view of a heating chamber.

[FIG. 4] is a partial vertical sectional view showing innards of a high frequency cooking device.

[FIG. 5] is a top view of a heating chamber bottom portion.

[FIG. 6] is a block configuration diagram of a high frequency cooking device.

[FIG. 7] is a partial vertical sectional view similar to FIG. 4 showing a state different from FIG. 4.

[FIG. 8] is a partial vertical sectional view showing innards of a high frequency cooking device according to a second embodiment.

[FIG. 9] is a partial vertical sectional view similar to FIG. 8 showing a state different from FIG. 8.

[FIG. 10] is a partial vertical sectional view showing innards of a high frequency cooking device according to a third embodiment.

[FIG. 11] is a top view of a heating chamber bottom portion for the third embodiment.

[FIG. 12] is a partial vertical sectional view similar to FIG. 10 showing a state different from FIG. 10.

[FIG. 13] is a partial vertical sectional view similar to FIG. 12 showing a disadvantage of a conventional structure.

### DESCRIPTION OF EMBODIMENTS

Hereinafter, a structure of a high frequency cooking device 1 according to a first embodiment is described with reference to FIG. 1 to FIG. 7. In FIG. 1, upper and lower sides of the page correspond to upper and lower sides of the high frequency cooking device 1. Besides, a left side of the paper surface corresponds to a left side of the high frequency cooking device 1, and a right side of the paper surface corresponds to a right side of the high frequency cooking device 1.

The high frequency cooking device 1 includes a housing 10 made of a rectangular parallelepiped-shaped sheet metal structure. A heating chamber 20 made of smaller parallelepiped-shaped sheet metal structure is disposed in the housing 10. The heating chamber 20 is provided with an opening at a front surface of the housing 10. The front of the housing 10 is provided with a metal door 11 that opens and closes the opening portion of the heating chamber 20. The door 11 is coupled at its left side end to the housing 10 by a hinge 12, and rotates in a horizontal plane around the hinge 12 that functions as a fulcrum.

The door 11 is provided with a window 13 for looking inside the heating chamber 20. A door screen 14 including a punching metal sandwiched between two glass plates is fitted in the window 13. The door screen 14 prevents an electromagnetic wave from leaking while keeping a see-through characteristic thereof. The door 11 is further provided with electromagnetic wave leakage preventing measures other than the door screen 14, a gasket for preventing gas leakage from the heating chamber, and a lock device for keeping a closed state of the door 11. However, these are all well-known art, so detailed description is skipped.

The housing 10 is provided with an operation panel 15 on a right side portion of the door 11. The operation panel 15 is provided with a group of membrane switches 15a and a dial 15b as operation interfaces. Above the membrane switches 15a, a display device 15c including a liquid crystal panel is disposed.

The housing 10 is supported on a table or a rest by a leg portion 16 (see FIG. 2). The leg portion 16 has four sole portions 16a located at left and right sides of front and rear sides, thereby forming a four-point support.

Next, innards of the high frequency cooking device 1 are described. On an outer surface of a right side wall of the heating chamber 20, a microwave generating device (magnetron) 21 is mounted. The microwave generating device 21 supplies a microwave into the inside of the heating chamber 20. The microwave generating device 21 is situated in a space of the housing 10 that corresponds to a rear side of the operation panel 15. In the same space, also a circuit board (not shown) composing a control device later described is disposed.

On the outer surface of the right side wall of the heating chamber 20, also an illuminating device 22 for illuminating the inside of the heating chamber 20 is disposed. The illumination device 22 uses a light emitting diode (LED) as a light source, and the right side wall of the heating chamber 20 is provided with a rectangular array of many light passing holes 24 for allowing light emitted from a plurality of LEDs 23 to pass through. The size and arrangement of the light passing holes 24 are the same as the holes of the punching metal of the door screen 14, and the electromagnetic wave does not leak from there.

The array of the light passing holes 24 is covered by a rectangular parallelepiped-shaped cover 25 from the outside of the heating chamber 20. The cover 25 encloses the LEDs 23 and defines a mount base for the LEDs 23. The cover 25 is formed of a punching metal, through which air for cooling the LEDs 23 can flow in and out.

The right side surface of the housing 10 is provided with an air exhaust port 17 including an aggregate of small holes, and at an inner side of the exhaust port 17 a cooling fan 18 is disposed. When the cooling fan 18 is operated, the air in the housing 10 is discharged from the air exhaust port 17, and air outside the high frequency cooking device 1 is sucked in from a not-shown suction port disposed at another portion of the housing 10. The sucked air flows to the cooling fan 18 and the air flow cools heat-generating components such as the microwave generating device 21, the LEDs 23, the circuit board and the like.

A bottom wall of the heating chamber 20 is provided with a rotary shaft insertion hole 26 at substantially a center thereof. In addition to this, on the bottom wall of the heating chamber 20, a shallow dimple 27 is formed with the rotary shaft insertion hole 26 at its center.

In the heating chamber 20, a turntable 30, on which a food to be heated is placed, is disposed. Objet to be heated in the high frequency cooking device 1 can be a solid, a fluid or a liquid, and in the present specification, the generic term “food” represents them. The turntable 30 is a planar circular-shaped glass member, and a top surface thereof is shallowly dimpled like a dish. The turntable 30 is supported above the bottom wall of the heating chamber 20 by a roller stay 31. As shown in FIG. 5, the roller stay 31 has a center hub 31a and three arms 31b protruding radially at angular intervals of 120 degrees from the center hub 31a. Each of the arm 31b holds a roller 31c at a tip end thereof. The rollers 31c contact both a floor of the dimple 27 and an undersurface of the turntable 30, thereby supporting the weight of the turntable and the food. The undersurface of the turntable 30 is provided with an annular rib 30a enclosing the three rollers 31c so that the turntable 30 does not deviate from the roller stay 31.

Rotation is transmitted to the roller stay 31 via a rotary shaft 31d. The rotary shaft 31d is integrally formed with the hub 31a to hang down from the hub 31a. The rotary shaft 31d passes vertically through the rotary shaft inserting hole 26. The rotary shaft 31d protruding from the bottom wall undersurface of the heating chamber 20 is fixed to an output shaft 32a of a motor 32.

The motor 32 is a vertical-shaft type one and is supported on the heating chamber 20 via a cup-shaped supporting base 33 that is fixed to an outer surface of the bottom wall of the heating chamber 20. The motor 32 incorporates a speed reducing mechanism to slow down the rotation of the output shaft 32a. At the portion where the output shaft 32a passes through the supporting base 33, a seal member 34 is disposed for preventing water from leaking from the inside of the supporting base 33 to the motor. An upper end of the supporting base 33 is welded to the bottom wall of the heating chamber 20 in a tight contact state so that no gas or liquid leaks through there.

Control elements of the high frequency cooking device 1 are shown in FIG. 6. A control device 40 is responsible for the overall control. The control device 40 is connected with the operation panel 15, the cooling fan 18, the LEDs 23, the motor 32 that are described above, and besides them, with the following constituent elements. Namely, a microwave drive power supply 21 that makes the microwave generating device 21 perform microwave oscillation, a temperature sensor 28 disposed in the heating chamber 20, and a door open/close sensor 11a disposed for the door 11.

Operation of the high frequency cooking device 1 is as follows. In a case where heating by a microwave is performed, a food to be heated is placed on the turntable 30, and in a state where the door 11 is closed, the membrane switch 15a of the operation panel 15 for issuing a command for “microwave cooking” is pushed. If the door open/close sensor 11a detects that the door 11 is surely closed, the microwave drive power supply 21a is powered, and the microwave generating device 21 starts the microwave oscillation. Thus, the food in the heating chamber 20 is heated by the microwave.

Together with the microwave drive power supply 21a, the cooling fan 18, the LEDs 23, and the motor 32 are also powered. The cooling fan 18 cools the heat-generating components in the housing 10 by an air flow it generates. The LEDs 23 illuminate the inside of the heating chamber 20. The motor 32 rotates the output shaft 32a, and the output shaft 32a rotates the roller stay 31.

When the roller stay 31 rotates, the rollers 31c roll on the floor of the dimple 27 with the turntable placed on the rollers. The rolling rollers 31c further push the turntable 30 placed on the rollers in the moving direction. An angular speed of the turntable 30 is about double an angular speed of the roller stay 31c.

In response to passage of a predetermined time, or operation by a user, or detection by a sensor disposed to detect that a food temperature reaches a predetermined value, or an output of a signal from the door open/close sensor 11a informing that the door 11 is opened, the control device 40 stops the operation of the microwave generating device 21, the cooling fan 18, the illuminating device 22, and the motor 32. If the cooking is completed, the user opens the door 11 and takes out the food.

The rollers 31c of the roller stay 31 do not support the outermost circumferential portion of the turntable 30 but portions nearer to a center of rotation. Because of this, as shown in FIG. 13, if force is exerted on a portion of the turntable 30 that extends beyond the roller stay 31, the turntable 30 could be tilted significantly to come off the roller stay 31.

To deal with the above problem, in the preferred embodiment of the present invention, a tilt limiting member for preventing the turntable 30 from being tilted by a predetermined angle or more is disposed between the undersurface of the turntable 30 and the bottom wall of the heating chamber 20.

In the first embodiment, the tilt limiting member is formed as described below. Specifically, a protrusion 50 is formed at a position of the bottom wall of the heating chamber 20 situated between the front side opening of the heating chamber 20 and the roller stay 31, and this protrusion 50 is used as the tilt limiting member. The protrusion 50 is formed, by press forming (draw forming), on a metal plate that composes the bottom wall of the heating chamber 20, and as shown in FIG. 5, includes a planar arc shape larger than the dimple 27 in diameter.

The protrusion 50 is formed at the position of the bottom wall of the heating chamber 20 situated between the front side opening of the heating chamber 20 and the roller stay 31, accordingly, even if a human hand touches an edge of the turntable 30 and the turntable 30 is tilted as shown in FIG. 7, the turntable 30 butts the protrusion 50 before being so tilted to come off the roller stay 31, and is not tilted any more. Because of this, if the force is lifted, the turntable 30 goes back onto the roller stay 31 and stably rotates at that position. The height of the protrusion 50 is preferably decided from results of experiments on how high the protrusion 50 needs to be to prevent the turntable 30 from coming off the roller stay 31.

A second embodiment of the present invention is shown in FIG. 8 and FIG. 9. In the second embodiment, the tilt limiting member is formed as described below. Specifically, an annular protrusion 51 is formed on the undersurface of the turntable 30 along an arc that is larger than the roller stay 31 in diameter, and this protrusion 51 is used as the tilt limiting member. The protrusion 51 is larger than the rib 30a in diameter and has a coaxial circular shape with the rib 30a.

The protrusion 51 is formed, whereby even if a human hand touches the edge of the turntable 30 and the turntable 30 is tilted as shown in FIG. 9, the protrusion 51 butts the bottom wall of the heating chamber 20 before the turntable 30 is so tilted to come off the roller stay 31, and is not tilted any more. Because of this, if the force is lifted, the turntable 30 goes back onto the roller stay 31 and stably rotates at that position. The height of the protrusion 51 is preferably decided from results of experiments on how high the protrusion 51 needs to be to prevent the turntable 30 from coming off the roller stay 31.

The protrusion 51 does not necessarily have a continuous annular shape. A plurality of short arc-shaped protrusions 51 or a plurality of dot-shaped protrusions 51 can be disposed at certain intervals.

A third embodiment of the present invention is shown in from FIG. 10 to FIG. 12. In the third embodiment, the tilt limiting member is formed as described below. Specifically, the neighboring arms 31b of the roller stay 31 are connected by a linking stay 52, and this linking stay 52 is used as the tilt limiting member. In the embodiment, the linking stays 52 form a ring.

The linking stay 52 is present, whereby even if a human hand touches the edge of the turntable 30, especially an intermediate position between the arms 31b, and the turntable 30 is tilted as shown in FIG. 12, the turntable 30 butts the linking stay 52 before being so tilted to come off the roller stay 31, and is not tilted any more. Because of this, if the force is lifted, the turntable 30 goes back onto the roller stay 31 and stably rotates at that position. The height of the linking stay 52 is preferably decided from results of experiments on how high the linking stay 52 needs to be to prevent the turntable 30 from coming off the roller stay 31.

The above first, second and third embodiments are not in an exclusive relationship. An overlapping use is also possible.

Hereinbefore, the embodiments of the present invention are described. However, the present invention is not limited to these embodiments, and various modifications can be added without departing from the spirit of the present invention and put into practical use.

### INDUSTRIAL APPLICABILITY

The present invention is widely applicable to high frequency cooking devices.

### REFERENCE SIGNS LIST

1 high frequency cooking device
10 housing
11 door
15 operation panel
18 cooling fan
20 heating chamber
21 microwave generating device
30 turntable
31 roller stay
32 motor
40 control device
50 protrusion (tilt limiting member)
51 protrusion (tilt limiting member)
52 linking stay (tilt limiting member)

1. A high frequency cooking device comprising:
a heating chamber that heat a food;
a roller stay which is disposed on a bottom wall of the heating chamber and rotates with a turntable placed thereon; and
a tilt limiting member that is disposed between an undersurface of the turntable and the bottom wall of the heating chamber; wherein
the tilt limiting member prevents the turntable from being tilted by a predetermined angle or more.

2. The high frequency cooking device according to claim 1, wherein
on the bottom wall of the heating chamber, a protrusion is formed at a position between a front side opening of the heating chamber and the roller stay, and the protrusion defines the tilt limiting member.

3. The high frequency cooking device according to claim 1, wherein
on the undersurface of the turntable, a protrusion is formed along an arc larger than the roller stay in diameter, and the protrusion defines the tilt limiting member.

4. The high frequency cooking device according to claim 1, wherein
the roller stay includes a plurality of arms, each of the arms is equipped with a roller at a tip end thereof, and the neighboring arms are connected by a linking stay, and the linking stay defines the tilt limiting member.
